(19) United States
(12) Patent Application Publication
(10) Pub. No.: US 2024/0286301 A1
(43) Pub. Date: Aug. 29, 2024

(54) Tool Bit Structure Convenient for Guiding Hairs During Vertical Cutting, and Hair Trimmer

(71) Applicant: Ningbo Unibono Appliance Co., Ltd., Ningbo, Zhejiang (CN)

(72) Inventor: Jianfeng Yan, Ningbo, Zhejiang (CN)

(21) Appl. No.: 18/024,047

(22) PCT Filed: Mar. 11, 2022
(86) PCT No.: PCT/CN2022/080315

§ 371 Date: Feb. 28, 2023

(30) Foreign Application Priority Data
Nov. 29, 2021 (CN) 202122947615.3
Mar. 8, 2022 (CN) 202220484635.3

(51) Int. Cl. B26B 19/06; B26B 19/38

(52) U.S. Cl. CPC B26B 19/06; B26B 19/3846

(57) ABSTRACT

Provided are a tool bit structure convenient for guiding hairs during vertical cutting, and a hair trimmer. The tool bit structure includes a stationary knife; the stationary knife is provided with a comb-tooth edge portion; the comb-tooth edge portion has a plurality of teeth; each tooth is provided with a step for preventing a movable knife from scraping the skin; all the steps are combined to form comb teeth convenient for guiding hairs during vertical cutting; and the steps protrude from the teeth at a height of 0.4 mm to 1 mm. The steps are added at the comb-tooth edge portion of the stationary knife, so that the steps can be used to prevent the movable knife from scratching the skin in a running process, and the comb teeth formed by combining all the steps can also comb the hairs during the vertical cutting, which facilitates guiding the hairs.

### TECHNICAL FIELD

The present disclosure relates to the technical field of hair trimmers, in particular to a tool bit structure convenient for guiding hairs during vertical cutting, and a hair trimmer.

### BACKGROUND ART

A tool bit portion of a hair trimmer generally includes a movable tool bit and a stationary tool bit. The movable tool bit can move back and forth relative to the stationary tool bit to achieve hair trimming. However, due to sharp teeth of the movable tool bit, in a hair trimming process, the movable tool bit that moves back and forth easily scratches the skin. As a result, a user has a poor experience. Furthermore, it is difficult to shave hairs during vertical cutting.

### SUMMARY OF THE INVENTION

In order to solve at least one aspect in the above problems, the present utility model first provides a tool bit structure convenient for guiding hairs during vertical cutting, including a stationary knife; the stationary knife is provided with a comb-tooth edge portion; the comb-tooth edge portion has a plurality of teeth; each tooth is provided with a step for preventing a movable knife from scraping the skin; and all the steps are combined to form comb teeth convenient for guiding hairs during vertical cutting.

Optionally, the steps protrude from the teeth at a height of 0.4 mm to 1 mm.

Optionally, upper surfaces of the steps are flush with an upper surface of a front end of the movable knife.

Optionally, the teeth have tooth tips; and the tooth tips upward extend to form the steps.

Optionally, the steps and the teeth are perpendicular to each other.

Optionally, the steps are provided with chamfers.

Optionally, a length of each step in a front-back direction is a, and a length of each tooth in the front-back direction is b, where b/3<a<b/2.

Compared with the prior art, the tool bit structure convenient for guiding hairs during vertical cutting in the present utility model has the advantages that the steps are added at the comb-tooth edge portion of the stationary knife, so that the steps can be used to prevent the movable knife from scratching the skin in a running process, and the comb teeth formed by combining all the steps can also comb the hairs during the vertical cutting, which facilitates guiding the hairs and then facilitates the movable knife to cut the hairs.

In addition, the present utility model provides a hair trimmer, including the foregoing tool bit structure convenient for guiding hairs during vertical cutting.

Compared with the prior art, the hair trimmer in the present utility model has the same advantages as the foregoing tool bit structure convenient for guiding hairs during vertical cutting, and descriptions thereof are omitted here.

### BRIEF DESCRIPTION OF THE DRAWINGS

FIG. 1 is a structural diagram I of a tool bit structure according to an embodiment of the present utility model;

FIG. 2 is a structural diagram II of a tool bit structure according to an embodiment of the present utility model; and

FIG. 3 is an enlarged diagram of a portion A in FIG. 2.

### REFERENCE NUMERALS IN THE DRAWINGS

1: stationary knife; 2: comb-tooth edge portion; 21: tooth; 211: tooth tip; 22: step; and 221: chamfer.

### DETAILED DESCRIPTION OF THE INVENTION

In order to make the foregoing objectives, features and advantages of the present utility model more obvious and understandable, the specific embodiments of the present utility model are described below in detail with reference to the accompanying drawings.

In the description of the present utility model, it should be understood that orientation or position relationships indicated by the terms “up” and “down” are based on orientation or position relationships of a product in normal use.

The terms “first” and “second” are only used for descriptive purposes, and should not be construed as indicating or implying relative importance or implicitly indicating the number of indicated technical features. Therefore, features defined by “first” and “second” can explicitly indicate or impliedly include at least one feature. A coordinate system XYZ is set in the accompanying drawing of embodiments of the present utility model. A forward direction of an X axis represents left, and a reverse direction of the X axis represents right; a forward direction of a Y axis represents front, and a reverse direction of the Y axis represents rear; and a forward direction of a Z axis represents top, and a reverse direction of the Z axis represents bottom.

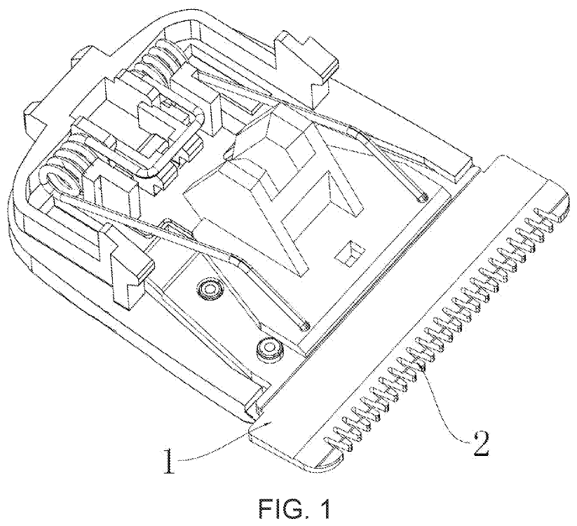

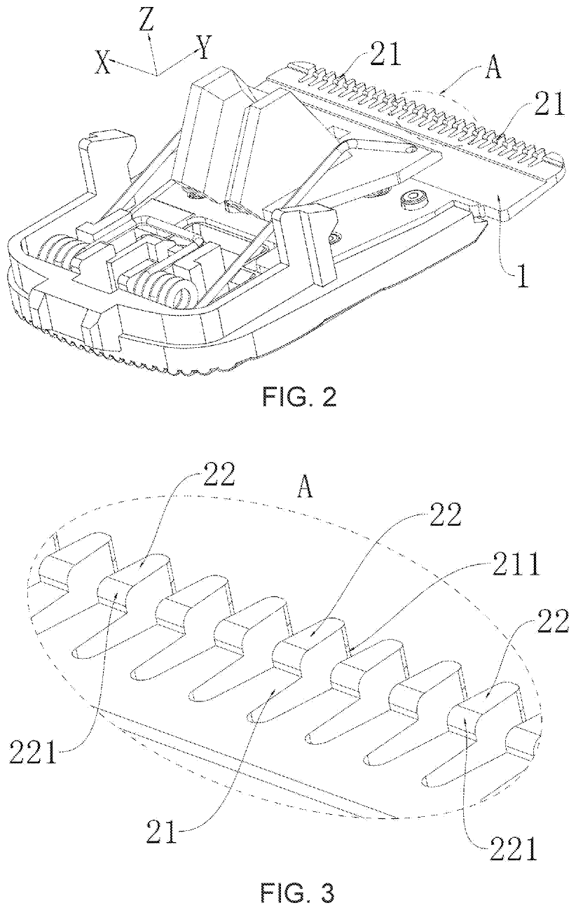

An embodiment of the present utility model provides a tool bit structure convenient for guiding hairs during vertical cutting. As shown in FIG. 1, FIG. 2 and FIG. 3, the tool bit structure includes a stationary knife 1. The stationary knife 1 is provided with a comb-tooth edge portion 2. The comb-tooth edge portion 2 has a plurality of teeth 21. Each tooth 21 is provided with a step 22 for preventing a movable knife (not shown) from scraping the skin. All the steps 22 are combined to form comb teeth convenient for guiding hairs during vertical cutting.

Vertical cutting refers to an operation for cutting hairs while the tool bit is perpendicular to the skin, for example, which is used in a case for shaving soft hairs or all hairs. By using the comb-tooth edge portion 2 on the stationary knife 1, hairs can conveniently enter the comb-tooth edge portion 2 when a hair trimmer trims hairs in a normal posture (a non-vertical cutting state), and it is convenient for the movable knife to trim the hairs. A small space is reserved between a front end of the movable knife and rear ends of the steps 22, which ensures that the movable knife can successfully move back and forth relative to the stationary knife 1 and can also ensure that the steps 22 can prevent the movable knife from scratching the skin during running.

According to the tool bit structure convenient for guiding hairs during vertical cutting in this embodiment, the steps 22 are added at the comb-tooth edge portion 2 of the stationary knife 1, so that the steps 22 can be used to prevent the movable knife from scratching the skin in the running process, and the comb teeth formed by combining all the steps 22 can also comb the hairs during the vertical cutting, which facilitates guiding the hairs and then facilitates the movable knife to cut the hairs.

Optionally, with reference to FIG. 3, the steps 22 protrude from the teeth 21 at a height of 0.4 mm to 1 mm.

The height refers to a height in an up-down direction. The height of the teeth 21 is set within a range of 0.4 mm to 1 mm, which can effectively prevent the movable knife from moving beyond the stationary knife 1. If the height is too small, the movable knife may possibly scratch the skin. If the height is too large, the movable knife cannot shave all the hairs successfully.

Optionally, with reference to FIG. 3, the steps 22 protrude from the teeth 21 at a height of 1 mm.

Optionally, with reference to FIG. 3, the steps 22 protrude from the teeth 21 at a height of 0.5 mm.

Optionally, with reference to FIG. 3, upper surfaces of the steps 22 are flush with an upper surface of a front end of the movable knife.

The upper surfaces of the steps 22 are flush with the upper surface of the front end of the movable knife, which can prevent the movable knife from scratching the skin, also ensure that the hairs can be completely trimmed by the movable knife and ensure the overall appearance.

Optionally, with reference to FIG. 2 and FIG. 3, the teeth 21 have tooth tips 211, and the tooth tips 211 upward extend to form the steps 22.

The tooth tips 211 are located at the front ends of the teeth 21. The steps 22 are disposed on sides of the teeth 21 close to the movable knife, so as to ensure that the steps 22 can guide the hairs to the movable knife for cutting during the vertical cutting. The steps 22 and the teeth 21 are integrally formed and can be structurally smoothly transitioned, so that the hairs can be successfully guided into the comb teeth.

Optionally, with reference to FIG. 2 and FIG. 3, the steps 22 are perpendicular to the teeth 21.

Rear end surfaces of the steps 22 are perpendicular to the upper surfaces of the teeth 21, so that the movable knife is close to the steps 22 as much as possible, which is convenient for the movable knife to trim the hairs guided by the comb teeth, and the structure is more compact.

Optionally, with reference to FIG. 3, the steps 22 are provided with chamfers 221.

The chamfers 221 are arranged at joints of the upper surfaces of the steps 22 and the rear end surfaces of the steps 22. The chamfers 221 can be arranged to prevent the steps 22 from scratching the skin during the vertical cutting and improve the safety of use.

Optionally, with reference to FIG. 1, FIG. 2 and FIG. 3, a length of each step 22 in a front-back direction is a, and a length of each tooth 21 in the front-back direction is b, where b/3<a<b/2.

The relationship between a and b is designed to be b/3<a<b/2, which will not affect guiding the hairs to the comb-tooth edge portion 2 during normal trimming of the hairs and can ensure that the hairs are successfully guided to the comb teeth during the vertical cutting. If a is less than b/3, the steps 22 are extremely short in the front-back direction, which may cause that the hairs cannot be successfully guided to the comb teeth during the vertical cutting. If a is greater than b/2, the steps 22 are extremely long in the front-back direction, overlapping portions of the movable knife and the comb-tooth edge portion 2 will be narrowed, which may cause that the movable knife cannot successfully trim all the hairs during the normal trimming and may reduce the trimming efficiency.

Another embodiment of the present utility model provides a hair trimmer, including the aforementioned tool bit structure convenient for guiding hairs during vertical cutting.

According to the hair trimmer in this embodiment, the steps 22 are added at the comb-tooth edge portion 2 of the stationary knife 1, so that the steps 22 can be used to prevent the movable knife from scratching the skin in the running process, and the comb teeth formed by combining all the steps 22 can also comb the hairs during the vertical cutting, which facilitates guiding the hairs and then facilitates the movable knife to cut the hairs.

Although the present disclosure is disclosed as above, the protection scope of the present disclosure is not limited thereto. Those skilled in the art can make various changes and modifications without departing from the spirit and scope of the present disclosure, and these changes and modifications shall all fall within the protection scope of the present utility model.

1. A tool bit structure convenient for guiding hairs during vertical cutting, comprising a stationary knife (1), wherein the stationary knife (1) is provided with a comb-tooth edge portion (2); the comb-tooth edge portion (2) has a plurality of teeth (21); each tooth (21) is provided with a step (22) for preventing a movable knife from scraping the skin; all the steps (22) are combined to form comb teeth convenient for guiding hairs during vertical cutting; and the steps protrude from the teeth at a height of 0.4 mm to 1 mm.

2. The tool bit structure convenient for guiding the hairs during vertical cutting according to claim 1, wherein the steps (22), are flush with an upper surface of a front end of the movable knife.

3. (canceled)

4. The tool bit structure convenient for guiding the hairs during vertical cutting according to claim 1, wherein the teeth (21) have tooth tips (211); and the tooth tips (211) upward extend to form the steps (22).

5. The tool bit structure convenient for guiding the hairs during vertical cutting according to claim 1, wherein the steps (22) and the teeth (21) are perpendicular to each other.

6. The tool bit structure convenient for guiding the hairs during vertical cutting according to claim 1, wherein the steps (22) are provided with chamfers (221).

7. The tool bit structure convenient for guiding the hairs during vertical cutting according to claim 1, wherein a length of each step (22) in a front-back direction is a, and a length of each tooth (21) in the front-back direction is b, wherein b/3<a<b/2.

8. A hair trimmer, comprising the tool bit structure convenient for guiding hairs during vertical cutting according to claim 1.
